(19) United States
(12) Patent Application Publication
(10) Pub. No.: US 2021/0352983 A1
(43) Pub. Date: Nov. 18, 2021

(54) BIOACTIVE FILTER FOR VIRAL DEACTIVATION

(71) Applicant: Daniel Francis Davidson, Santa Clara, UT (US)

(72) Inventor: Daniel Francis Davidson, Santa Clara, UT (US)

(21) Appl. No.: 16/912,454

(22) Filed: Jun. 25, 2020

Related U.S. Application Data
(60) Provisional application No. 63/024,233, filed on May 13, 2020.

(51) Int. Cl. A41D 13/11; C08J 5/18; C08L 27/18; A41D 31/30

(52) U.S. Cl. CPC A41D 13/1192; C08J 5/18; C08J 2327/18; A41D 31/305; C08L 27/18

(57) ABSTRACT

A bioactive filter has at least one layer comprising at least one transitional element or compound (e.g., iron, cobalt, nickel, zinc, etc.). The bioactive filter deactivates a virus based on the charge of the transitional element incorporated into the filter design. The transitional element may be found in the at least one layer in nanoparticle form. Upon interdiction of the virus in the filter, the transitional element mimics the charge or shape of the ACE-2 receptors and the virus falsely attempts to infect the transitional element contained in the at least one layer of the bioactive filter, thereby deactivating the virus.

### CROSS-REFERENCE TO RELATED APPLICATIONS

This application claims the benefit of U.S. Provisional Application Ser. No. 63/024,233, filed on May 13, 2020, which is incorporated herein by reference.

### TECHNICAL FIELD

The present disclosure relates to a filter. More particularly, the present disclosure relates to a filter that deactivates a virus by using a transitional element.

### BACKGROUND

With outbreaks of virus-induced pandemics in recent years, exposure to viral loads in the human population can be linked to ejected aerosols, person-to-person contact, and contact with surfaces. The virus can enter a host upon the host touching entry points, such as the face or potentially his/her face mask. Viruses are prevalent in society and have been around for countless years, causing many sicknesses, deaths, and disruptions to everyday life. In some instances, viruses may cripple governments and bring world economies to near shutdown.

Individuals have attempted to curtail the effects of viruses with mixed results. For example, some attempts of curtailing viruses have come through the creation of vaccines and other attempts have been shown in clothing, such as face masks. Although masks may help in some situations, they are not a failsafe option because the simple act of replacing the filters on a full face mask or changing a mask that covers the mouth and nose may lead to infection of a wearer. Additionally, HEPA filters may provide a margin of capture for many viruses, but the HEPA filters do not deactivate the virus and could therefore act as a surface for transmittance.

Even with years of progress in science and technology, combating a virus may prove to be extremely difficult.

Accordingly, there is a need for a filter that can deactivate entrapped viral loads and can be used in numerous situations, such as in a face mask, subway, hospital, house, or others.

### SUMMARY OF EXAMPLE EMBODIMENTS

In one embodiment, a bioactive filter comprises at least one layer having a substrate comprising at least one transitional element or compound (e.g., iron, cobalt, nickel, zinc, etc.). The bioactive filter deactivates a virus based on the charge of the transitional element, having a high positive charge, incorporated into a filter layer. Transitional elements, or compounds that contain a positive charge, may prove useful—especially if the charge can be found on two sites/ends of the compound. The transitional element may be in nanoparticle form. It will be appreciated that the bioactive filter may be a conventional filter unit, a face mask, a full face mask, or contained as a filter in an air purification system, such as those found in health care facilities. Further, the at least one layer may be electrospun or in membrane form, and may further comprise a hydrophobic layer, such as ePTFE.

In one embodiment, a bioactive filter comprises at least one layer comprising at least one transitional element or compound with a charge of positive 2 valence (e.g., zinc) for interacting with a virus species.

### BRIEF DESCRIPTION OF THE DRAWINGS

FIG. 1 illustrates a detailed view of a bioactive filter.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a filter that can deactivate entrapped viral loads and can be used in numerous situations, such as in a face mask, subway, hospital, house, etc.

The recent outbreak of Covid-19, a virus of Chiroptera origin, has created a worldwide pandemic and devastated most economies of the world while killing thousands and infecting many. This virus is a respiratory virus that attacks angiotensin-converting enzyme 2 (ACE 2) in the cell membranes of the lungs, which can result in complication and death. Other enzymes and receptors may be involved with other virus species. While attempts of creating a vaccine are ongoing, other means of protection have been utilized to protect against this virus, such as medical masks as well as woodworking masks. Many have been forced to use these rudimentary protective articles with little to no success because a wearer often touches the mask or has to place new filters in the mask—which places the virus on access points on the wearer. In addition, the masks or filters may allow a virus to pass through, which may then enter the host.

In contrast, the bioactive filter described herein comprises at least one layer with a transitional element. The bioactive filter may be in a facemask or any other filtration system. Metals from the transitional region of the periodic table (e.g., zinc) have been shown to inhibit viral transmission and have been used to help defeat other viruses, such as the common cold. The deactivation of the coronavirus, and other types of viruses, may come by coupling a transitional element into at least one layer of a filter (the “bioactive” layer of the filter, or “bioactive filter”). When the virus contacts the this bioactive layer of the filter, the transitional element disrupts the virus by mimicking the metalloprotein interface of the ACE-2 receptor found in many cells in the human host (e.g., lungs and heart) and thereby deactivates the virus by false association with this receptor. This use of positively charged elements and compounds may prove useful for other virus species to mimic the enzymes and receptors attacked by these species. The bioactive filter may deactivate viruses that come in contact with the at least one bioactive layer, thereby creating a safer and more efficient filter.

More specifically, it has been shown that COVID-19 enters the host and seeks entrance into cells via the ACE-2 protein. Certain individuals may be more susceptible to the virus based upon the number of ACE-2 proteins on their cells. As the virus enters the cells via, for example, receptor-mediated endocytosis, the genetic material contained in the virus is released into the cytoplasm of the cell. At this point, the genetic material is replicated by the ribosomes in the cell and new viruses are assembled where they can lyse the cell and attack other cells in the host or be spread to other hosts. The key to stopping a virus may be to deactivate the virus prior to entering a host. The bioactive filter herein seeks to not only prevent entrance of the virus into the host, but to deactivate the virus to prevent further spreading. Even if the virus were to pass through the bioactive filter, the now deactivated virus would not cause harm to the host. In fact, the deactivated virus may be helpful to the host, allowing the host cells the opportunity to contact the deactivated virus and potentially start an immune response to protect the host from future infections.

However, before this can happen, the virus must be deactivated. To deactivate the virus, the virus must attach to a receptor, such as a transitional element that mimics the receptor found on the ACE-2 protein. As briefly discussed above, transitional elements may be the key to virus deactivation. Many of these transitional elements mimic the metalloprotein interface of the ACE-2 receptor and may be configured to mimic other proteins and receptors used by other virus species. With that being said, the virus is constantly looking for a host so that it may survive. After entering the bioactive filter, the virus discovers a binding site (i.e., the transitional element) that is similar to, or mimics, the ACE-2 receptors on cells in the lungs, heart, arteries, etc. The similarities of the receptor binding sites on the ACE-2 proteins and on the transitional elements comes from the fact that many of the orbitals of transitional elements are not filled when incorporated into a matrix, leading to a positive charge. This high positive charge may signal the virus, and potentially other viruses, to attach to the transitional element by false association, thinking that 1) the transitional element is a metalorganic substrate found at or near the ACE-2 receptors; 2) is the ACE-2 receptor in the cells; or 3) are enzymes associated with the receptors. Once the virus binds with the transitional element, it is deactivated. Accordingly, the bioactive filter may prevent many individuals from becoming extremely ill or dying.

While other filters in the prior art may trap a virus, the virus is not deactivated. Accordingly, deactivation of the virus, in addition to trapping the virus, is a desired result to prevent further spreading of the virus. For example, while a filter system may attempt to remove viruses in the air, these active viruses may still be found on or around the filtration system. In contrast, the bioactive filters disclosed herein seek to remove the threat of an activate virus by deactivating it. Without a bioactive filter, a virus will continue to live on a facemask, air filtration system, or any other filter until the virus is not viable, which may be hours or, sometimes, days.

Therefore, in one embodiment, a bioactive filter comprises at least one layer comprising at least one transitional element or compound (e.g., iron, cobalt, nickel, zinc, etc.). The transitional element may be coupled to the layer using a substrate, although not required. The bioactive filter may deactivate a virus based on the charge of the transitional element incorporated into the filter design. In addition, the at least one layer may be hydrophobic. However, the at least one layer may not be limited to a hydrophobic layer and may be a hydrophilic layer. The bioactive filter may be made of any suitable material known in the art of filters, such as paper, foam, cotton, etc. In some embodiments, the bioactive filter may comprise a plurality of filters, such as an outer layer, membrane layer, inner layer, etc. The at least one transitional element or compound contains a positive charge and may prove useful especially if the charge can be found on two sites/ends of the compound, producing two binding sites for the virus. The at least one transitional element may be sprayed onto the at least one layer, woven into the layer, soaked onto the layer, or any other mechanism for coupling the transitional elements to the at least one layer. It should be noted that not only can the charge of the transitional element deactivate a virus, but the shape of the transitional element may be important in attracting and deactivating the virus.

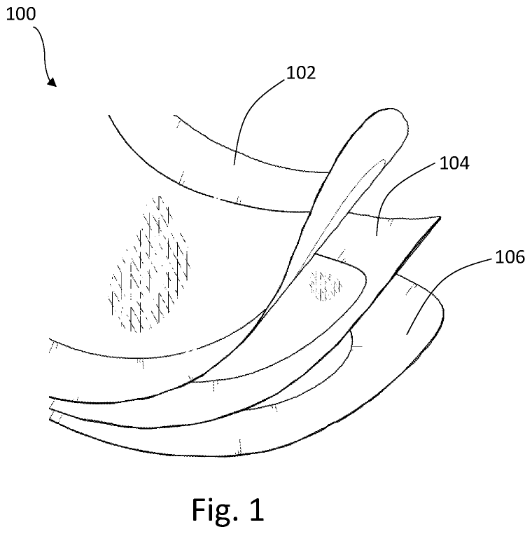

FIG. 1 is a detailed view of a bioactive filter 100. In one embodiment, the bioactive filter 100 may comprise a plurality of layers 102, 104, 106, wherein at least one layer 102, 104, 106 comprises a transitional element having a positive charge (the “bioactive layer”). In one embodiment, the two external layers 102, 106 comprise a transitional element while the internal layer 104 is a traditional filter. In another embodiment, the internal layer 104 comprises a transitional element while the outer layers 102, 106 are traditional filters. Further, in one embodiment, all layers 102, 104, 106 comprise a transitional element. It will be appreciated that while illustrated as having three layers, the bioactive filter 100 is not so limited and any number of layers may be used, including as few as one layer—in which case the single layer would be the bioactive layer as well (i.e., comprises a transitional element).

In one embodiment, at least one transitional element may be in nanoparticle form. In some embodiments, the bioactive filter may comprise a plurality of transitional elements so as to increase the likelihood of the virus becoming deactivated. It will be appreciated that the bioactive filter may be a conventional filter unit, configured as a face mask, a full face mask, or contained as a filter in an air purification system, such as those found in health care facilities, houses, buildings, planes, subways, etc. Further, the incorporation of the at least one bioactive layer, configured with something as simple as a cigarette filter, as long as it incorporates a positively charged transitional element, that is not toxic to the host, may be useful.

In one embodiment, the at least one layer may be electrospun, or in membrane form, and may comprise, for example, a hydrophobic layer, such as ePTFE. In one embodiment, a bioactive filter comprises at least one layer comprising a substrate comprising at least one transitional element or compound with a charge of positive 2 valence (e.g., zinc) interacting with a virus species.

Methods and processes in the art may be used to make a bioactive layer. For example, U.S. Pat. No. 4,985,296 to Mortimer and U.S. Pat. No. 3,953,566 to Gore, both of which are incorporated herein by reference, describe methods for achieving the incorporation of metals into a filter layer. Mortimer teaches a way to incorporate elements foreign to the PTFE polymer into an ePTFE structure in a way that pinholes are minimized or eliminated. This is valuable for the incorporation of metals, specifically conductive metals and more specifically transitional elements or compounds that contain a positive 2 charge within their makeup. These nanoparticles of the zinc element are available in various sizes. These nanoparticles of the preferred zinc element are available from Sky Spring Nano materials Inc. Further, un-coagulated PTFE resin is available from several sources, including E.I. Dupont, such as Teflon™ PTFE Dispersion 40 un-coagulated resin. Other part numbers and suppliers are available and will suffice for use herein. One such part number is D-310 available from Daikin America.

Again, using the teachings of Mortimer, a 50% by weight of zinc nanoparticles are added to this dispersion and energy applied, usually in the form of agitation, such as a mixer, which causes the nanoparticles to become incorporated into the PTFE dispersion while also causing the coagulation of the PTFE primary particles to agglomerate into a form that is further processable. One skilled in the art will recognize this transformation as the PTFE, and nanoparticles will separate from the aqueous dispersion and form agglomerates usually on the surface of the container vessel.

This mixture may be dried, frozen, and ground to a fine powder and mixed with a lubricant at about 14% by weight with the PTFE-Zinc mixture. A typical lubricant is Isopar K, available from Exxon Mobile and many distributors for Exxon in locations around the world. This mixture can be formed into an ePTFE membrane of limited thickness and containing the Zinc nanoparticles at a porosity that can serve as a filter membrane. Specifically following these teachings, the lubricated mixture is formed into a billet under pressure and extruded using a paste type extruder through a duck-bill type die that utilizes a cross section area change between 20 and 150, most preferably around 80:1 to form a flat sheet of PTFE mixture about 0.65 mm thick and 15 cm wide. Again, following the previous teachings, this flat ribbon can be run between two nips with a specific gap to reduce the thickness of the ribbon.

At this point in this process, the lubricant is removed by heating the ribbon to a temperature high enough to drive off the lubricant, usually above 200° C. for time to vaporize the Isopar K. Alternatively, the lubricant may be removed via chemicals or different time temperature selections to achieve the same results. The membrane is then stretched so as to create a suitable membrane for the bioactive filter. The dried ribbon may then be stretched at a ratio of 10:1 to dry the ribbon, thereby elongating the ribbon and decreasing its thickness. The resultant “film” is now referred to as ePTFE or expanded PTFE and has different properties from the resin used for its fabrication. The ribbon may be stretched at a temperature of 295° C. However, the temperature is not limited to 295° C. nor is the ratio. Accordingly, different temperatures and ratios may provide for flexibility and different properties of this “film.”

The “film” is further stretched to increase its width and decrease its thickness in a direction opposite the prior stretching, which is referred to as the transverse direction and is often performed on a tenter frame. The tenter frame is a machine designed to pull materials to increase the width in the presence of heat, normally around 295° C. It is expected that a ratio of the width to the input width will be about 10:1 to provide for properties necessary for a filter. However, it will be appreciated that the input width is not limited to the ratio of 10:1 and may be other suitable ratios. The resulting “membrane” will contain nanoparticle of zinc with a charge that will deactivate the viral species on contact by mimicking the ACE-2 receptor charge.

Other receptors can be mimicked using this or other transitional elements or compounds separate, or in conjunction with, the stated example. It is understood that one skilled in the art may use different recipes to achieve the same goal of virus deactivation and the elements-compounds may be changed to mimic the ACE-2 receptors used by coronavirus species or for other receptors and enzymes, such as the DPP4 for invasion into the host found in MERS outbreak.

In another example of the present invention the nanoparticles of transitional elements can be incorporated into an ePTFE membrane by mixing the nanoparticles directly with the PTFE powder before extrusion and preforming the resin into billets. This mixture is then lubricated with Isopar or other lubricants, as described by Mortimer or Gore, or as can be found throughout PTFE literature. Following the teachings of the '566 patent to Gore, among others, this blended PTFE mixture can be formed into suitable membranes for filter use, resulting in the bioactive filter discussed herein.

In yet another example, a blended mixture of PTFE can be stacked with layers of PTFE that have not been mixed with transitional nanoparticles or compounds in the preform stage by providing barriers between the two mixes or multiple layers of each mixture. The extrusion of these stacked layers and subsequent processing of this ribbon in accordance with the teachings of the '566 patent will produce very thin layers of nanoparticles that are incorporated and bound to a hydrophobic layer for use in personal mask and public filtration, such as public transportation. Although traditionally preform barrels and extrusion barrels are cylindrical in shape, a square or rectangle shape could be fabricated to further facilitate this layering and enhanced layer connectivity of the membrane.

It may prove useful to electrospin this layer of transitional elements to provide for virual deactivation. Multiple patents have been filed on this; however, two such patents may provide for a way to produce a non-woven, randomly oriented, membrane useful for filtration to provide for the transitional elements of the present invention. U.S. Pat. No. 10,456,724 to Huang et.al. describes a nanofibrous web of various sizes with a high electrostatic charge. With the incorporation of finely divided transitional elements in the spinning mixture, a suitable membrane of the present invention could be fabricated with inclusion of polypropylene, which could increase the durability of the membrane and act as a bonding agent for the transitional elements. Further, rotational spinning has been used to produce fibers of PTFE useful for medical application and for formation of membranes. U.S. Pat. No. 10,675,850 to Hall et. al. is a description of such a process and the incorporation of transitional nanoparticles into the dispersion before spinning will lead to a suitable membrane of the present invention. The literature contains many different ways to electrospinning polymers that are suitable for incorporation and construction of a suitable filter of the present invention. Because of the non-woven and random nature of this process, electrospinning of transitional elements in conjunction with polymers may be a preferred embodiment of the present invention. It is expected that those skilled in the art will have many other ways to manufacturer the present invention and it is in no way limited to the examples described. Both the '724 patent and the '850 patent are incorporated herein by reference in their entireties.

The deactivation of viruses before entry into a host may save countless lives, money, and prevent world economies from crashing. If the virus can be deactivated by charge and/or shape of elements or compounds mimicking ACE-2 receptors before entry into the host, such as by using the bioactive filter disclosed herein, many hospital cases may be eliminated. Additionally, virus and viral components that are able to penetrate the bioactive filter may benefit the wearer greatly if the virus is deactivated, allowing an immune response without a threat of infection.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A bioactive filter for deactivating a virus, comprising:
at least one layer;
at least one transitional element coupled to the at least one layer for deactivating the virus.

2. The bioactive filter of claim 1, wherein the at least one layer is hydrophobic.

3. The bioactive filter of claim 2, wherein the hydrophobic layer comprises ePTFE.

4. The bioactive filter of claim 1, wherein the at least one layer is electrospun.

5. The bioactive filter of claim 1, wherein the at least one layer is in membrane form.

6. The bioactive filter of claim 1, wherein the at least one layer comprises a membrane comprising the at least one transitional element.

7. The bioactive filter of claim 1, wherein the at least one transitional element is zinc.

8. The bioactive filter of claim 1, wherein the at least one transitional element is cobalt.

9. The bioactive filter of claim 1, wherein the at least one transitional element is in nanoparticle form.

10. The bioactive filter of claim 1, wherein the at least one layer comprises a substrate, the at least one transitional element coupled to the at least one layer via the substrate.

11. The bioactive filter of claim 1, wherein the bioactive filter is a facemask.

12. The bioactive filter of claim 1, wherein the bioactive filter is an air purification filter.

13. A bioactive filter for deactivating a virus, comprising:
at least one layer for deactivating the virus, the at least one layer comprising:
at least one transitional element with a charge of positive 2 valence,
wherein the at least one transitional element is in nanoparticle form; and
wherein when the virus enters the at least one layer, it binds to the at least one transitional element and is deactivated.

14. The bioactive filter of claim 13, wherein the at least one layer is electrospun.

15. The bioactive filter of claim 13, wherein the at least one transitional element is zinc.

16. The bioactive filter of claim 13, wherein the bioactive filter is an air purification filter.

17. The bioactive filter of claim 13, wherein the bioactive filter is a facemask.

18. The bioactive filter of claim 13, further comprising ePTFE.

19. A bioactive filter for deactivating a virus, comprising:
at least one layer;
at least one transitional element coupled to the at least one layer for deactivating the virus;
wherein the at least one transitional element is coupled to the at least one layer via mixing the at least one transitional element with a lubricant; the at least one transitional element and lubricant is formed into a billet under pressure and extruded and formed into a flat sheet; the lubricant is then removed from the flat sheet by heating; and the flat sheet is then stretched for coupling to the bioactive filter.
